(19) United States
(12) Patent Application Publication
(10) Pub. No.: US 2009/0306849 A1
(43) Pub. Date: Dec. 10, 2009

(54) SYSTEM FOR DIAGNOSIS OF MOTOR VEHICLES, AND FOR RECEPTION OF VEHICLES AT A REPAIR FACILITY

(75) Inventors: Martin Blanz, Schweiberdingen (DE); Thomas Bueckle, Bernstadt (DE); Gerald Grau, Waiblingen (DE); Ralf Lueg, Althengstett (DE); Manuel Rieger, Fellbach (DE); Markus Scholz, Winnenden (DE); Ralf Traub, Stuttgart (DE); Klaus Weiss, Gruibingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLER AG, STUTTART (DE)

(21) Appl. No.: 12/298,016

(22) PCT Filed: Apr. 4, 2007
(86) PCT No.: PCT/EP07/03046

§ 371 Date: Jan. 22, 2009

(30) Foreign Application Priority Data
Apr. 22, 2006 (DE) 10-2006-018831.4

(51) Int. Cl. G01M 17/00

(52) U.S. Cl. 701/33

(57) ABSTRACT

In a diagnostic system, messages which have occurred are collected and buffered with a short diagnostic test which is implemented in a control unit onboard the vehicle. The collected data are then transmitted into a memory area of the portable electronic driving authorization record, which therefore always contains the result of a short diagnostic test which has been carried out onboard. The result of this short diagnostic test is read out from the memory of the driving authorization record with a computer system in the customer reception of a servicing workshop, and is processed with a more wide-ranging diagnostic algorithm which builds on the result of the short diagnostic test.

This application is a national stage of International Application No. PCT/EP2007/003046, filed Apr. 4, 2007, which claims priority under 35 U.S.C. §119 to German Patent Application No. 10 2006 018 831.4, filed Apr. 22, 2006, the entire disclosure of which is herein expressly incorporated by reference.

### BACKGROUND AND SUMMARY OF THE INVENTION

The invention relates to a motor vehicle diagnostic system for determining, storing and transmitting diagnostic data from control units in a motor vehicle to a computer outside the motor vehicle. The system is comprised of components which are located both inside and outside the vehicle. The onboard components are capable of interrogating and buffering autonomous diagnostic data from control units, and the diagnostic data of the onboard components can be processed further using the offboard components. According to a feature of the invention, assistance is provided to the service employee at the vehicle reception of a servicing workshop.

A computer-supported diagnostic system which produces a weighted list of the possibly faulty motor vehicle components using a diagnostic program from vehicle data and customer details is disclosed, for example, in German patent document DE 102005015664. The identification of the possible fault candidates is carried out by evaluation of a control table which represents the diagnostic knowledge. The fault search space is expanded by additionally evaluating vehicle functions which may also possibly be affected by the fault candidates. The service technician can restrict the troubleshooting to selected fault codes or functions by setting a focus within the determined fault search space. Only the possible candidates for the selected fault codes or functions are then considered. The fault candidates which are associated with this focus set are weighted by calculating a plurality of fault probabilities for fault codes, components and affected functions. Alternatively, fault patterns which are still known for the calculation (that is, associated fault codes which also occur together) can be added.

Using an interactively operating diagnostic program the service technician sets a focus within a fault search space (initially defined by the diagnostic program) of the components or functions which are identified as possibly defective, for the further automated troubleshooting by the diagnostic program. The focus can be set by restriction to a fault code or by restriction to a function. In this diagnostic program it is, in particular, possible to allow customer details on functioning and non-functioning component systems also to be included in the diagnostic process. The diagnostic program permits, in particular, the processing of fault functions which are known only symptomatically, such as is usually the case when customers make complaints.

The provision of assistance to the head of the workshop in the vehicle reception and when receiving vehicles has until now been disclosed in the two patent applications: EP 0895198 A2 and DE 195 45 888 A1. Here, the driver of the vehicle hands in his transponder key for the remote-controlled central locking of the vehicle at the vehicle reception of the servicing workshop. The key is then plugged into a reading device, and read out. A separate transmitter, which operates at the frequency of the central locking system can be used to transmit the key identifier to the central locking gateway, and in a further step the control units in the shut down motor vehicle can be awakened. In such a step it may then be possible to read out the diagnostic data from the control units of the motor vehicle into a diagnostic tester in the workshop via a mobile radio link. The diagnostic data can therefore already be read out at the reception for repair work.

In addition to transponder keys, what are referred to as Keyless Go systems are becoming increasingly important and gaining acceptance. An exemplary Keyless Go system for a motor vehicle is described, for example, in German patent document DE 198 39 355 C1. Authentication data are stored here in a chip on an authentication element which is similar to a chip card. Furthermore, a microcontroller and communication systems in the form of transmitting and receiving units as well as a battery for supplying power to the microelectronic units on the authentication element are accommodated on the data carrier. Likewise, transmitting and receiving units which irradiate an electromagnetic field in a plurality of spatial zones around the vehicle using suitable antennas are also located on the vehicle. If the authentication element is located within one of these spatial zones, a communication link is set up between a control unit in the vehicle and the authentication element.

Both a transponder key and a Keyless Go authentication element therefore have, as portable driving authorization records, a microelectronic chip which can be read from and written to, and means for setting up a communication link.

One object of the invention is therefore to provide a diagnostic system which makes better use of the driving authorization records of the modern vehicles for vehicle reception in a servicing workshop.

This and other objects and advantages are achieved by the diagnostic system according to the invention, in which the fault messages which have occurred are collected and buffered with a short diagnostic test onboard which is implemented in a control unit of the vehicle, and said data are then transmitted into a memory area of the portable electronic driving authorization record. The driving authorization record therefore always contains the result of a short diagnostic test which has been carried out onboard. The result of this short diagnostic test is read out from the memory of the driving authorization record with a computer system in the customer reception of a servicing workshop, and is processed with a more wide-ranging diagnostic algorithm which builds on the result of the short diagnostic test.

The more wide ranging diagnostic algorithm displays the read-in short test result to the service employee, on a display of the computer system in the customer reception, including the individual fault messages in a selectable, alternative program loop in the form of a selection menu with input mask. The service employee can then request further information on individual fault messages from the driver of the vehicle in the customer reception, and input the requested customer complaints into the more wide ranging diagnostic system as additional fault symptoms for the respectively selected fault message. The diagnostic system from German patent document DE102005015664, referred to previously, can be used as a more wide ranging diagnostic system if it is supplemented by the system components, disclosed here, for the short diagnostic test, and with the possibilities of reading out and reading in the result from the short diagnostic test from the driving authorization records. The customer complaints are then included in the further diagnostic process.

In one embodiment of the diagnostic system according to the invention, the driving authorization records are provided in a transponder key. In this case, a reading device for the transponder key must be held in readiness in the customer reception. Such a reading device would have a communication link to the computer system in the customer reception, and can be used to read out the data from the transponder key and transmit it into the computer system in the customer reception.

In a further embodiment of the diagnostic system according to the invention, the driving authorization records are provided in an authentication element of a Keyless Go system. In this case, the transmitting and reception system which is associated with the Keyless Go system in the customer reception is connected to the computer system in the customer reception, and the result of the short diagnostic test is therefore read out of the authentication element and transmitted into the computer system.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a graphic system overview of onboard and offboard components of a transponder key based system;

FIG. 2 shows a graphic system overview of onboard and offboard components of a Keyless Go based system; and

FIG. 3 shows a possible method sequence of the customer reception of a servicing workshop.

### DETAILED DESCRIPTION OF THE DRAWINGS

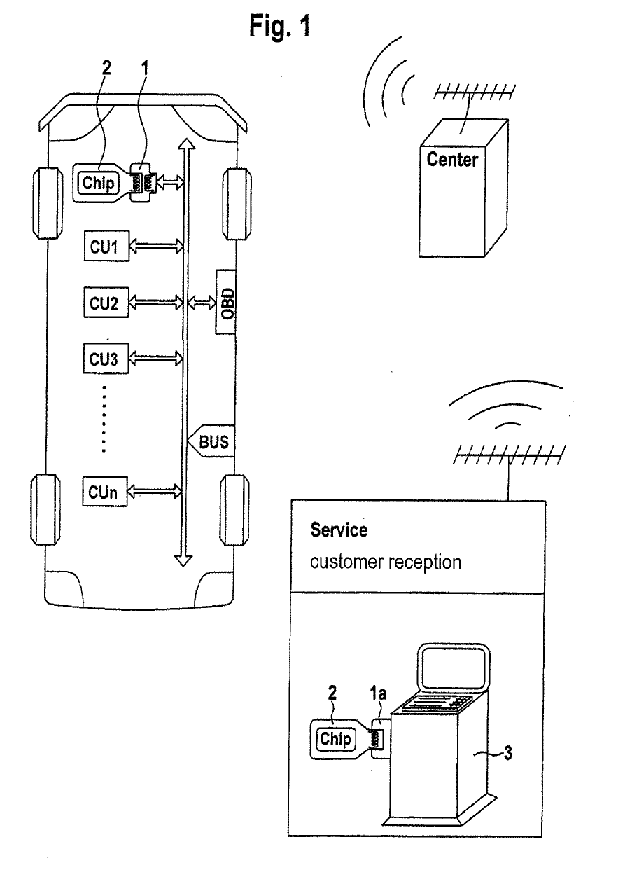

A first exemplary embodiment of the diagnostic system according to the invention is illustrated in FIG. 1. In an onboard motor vehicle network a plurality of control units or microcontrollers CU1, CU2, CU3, CUn are installed, and perform various tasks and functions in the vehicle. Each of these control units has a self-diagnostic routine with which it can carry out self-checking of its functions, detect predefined faults and classify them with a fault code. These possibly identified fault codes are stored in fault memories in the onboard vehicle network. The various control units exchange data with one another over at least one data bus. (They can, of course, be networked to one another via a plurality of different bus systems.) At the junction of two different bus systems, gateways, which translate the different bus protocols, are then provided. Via a diagnostic interface OBD, it is then possible to access the communication network in the motor vehicle from the outside with a diagnostic tester, and therefore access the connected control units and read out their fault memories. The reading-in station 1 for the driving authorization system, which is to be formed from a transponder key in the exemplary embodiment in FIG. 1, is also connected to the communication network. If the transponder key is plugged into the reading-in station, a test program reads out the driving authorization code from a chip on the transponder key and checks it. If the driving authorization is present in a positive form, immobilizers are deactivated and the starting authorization is enabled. To this extent, the addressed systems correspond to the prior art which is known and is to be assumed for the invention.

According to the invention, a short diagnostic test is performed in one of the control units or microcontrollers which are connected to the communication system in the vehicle. This short diagnostic test includes collecting the fault memory data and other vehicle data from the connected control units and, if appropriate, also logging fault messages on the bus systems of the onboard vehicle network and buffering the collected diagnostic data in a suitable medium in the onboard vehicle network.

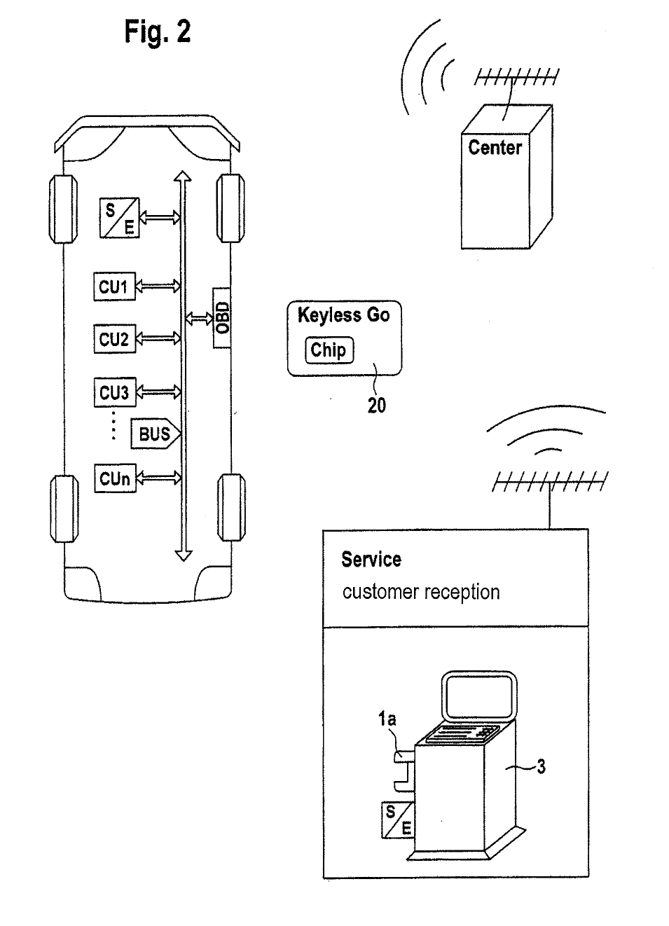

The short diagnostic test therefore has, on the one hand, the function of a data collector for onboard diagnostic data. It also transmits and stores the buffered diagnostic data into a memory area on the chip of the driving authorization record at a suitable time. The electronic driving authorization record may be a transponder key as in FIG. 1 or a chip card as an authentication element of a Keyless Go system as in the exemplary embodiment in FIG. 2. In both exemplary embodiments, a suitable time for this transmission of data is in all cases just after the motor vehicle starts. In addition to the collected data, an identifier for the time is buffered. After the internal combustion engine starts, the collected and buffered data are transmitted to the driving authorization record for the first time.

Further transmissions can occur controlled in a triggered fashion. Whenever a new fault message is transmitted on one of the bus systems while the vehicle is operating, the diagnostic data are collected and buffered from the short diagnostic test, and then immediately transmitted into the memory area of the driving authorization record.

A last transmission of the diagnostic data may possibly occur when the vehicle is shut down. However, transmission of data to the driving authorization records may, under certain circumstances, fail if the driving authorization records is pulled out too quickly by the driver of the vehicle. However, it is always certainly possible to buffer the collected diagnostic data. When a transmission attempt fails, the set of diagnostic data which was buffered last is transmitted next time the vehicle is started. A microcontroller has to monitor the transmission of the data and the storage on the driving authorization records. The diagnostic data which was stored last may be overwritten only if a transmission attempt was successful. This can be ensured by corresponding configuration of the transmission protocols and of the storage routines. Under certain circumstances, a buffer memory, in which the diagnostic data are initially saved in a volatile fashion up to complete transmission before they are stored in a nonvolatile memory area of the chip, has to be made available on the chip of the driving authorization records.

Moreover, the diagnostic data can also be stored cyclically while the vehicle is operating.

A specific trigger condition may be provided in order to start a transfer of the short test diagnostic result onto the chip of the electronic driving authorization records shortly before the vehicle is shut down. The transfer of the diagnostic data is then started by the program module of the short diagnostic test, if the motor vehicle drops below a velocity of 10 km/h. For this purpose, the current velocity is also read in on the communication system of the vehicle by the sequence controller of the short diagnostic test. The detection of the velocity of the vehicle can include a hysteresis detection which detects if the vehicle is accelerated and braked repeatedly about the 10 km/h limit in stop and go traffic. In this case, a transmission is not carried out whenever the velocity drops below the 10 km/h limit but rather, for example, is carried out again only if the vehicle has moved at a relatively high velocity for a relatively long time.

If the vehicle goes into a workshop for a service, the diagnostic data from the chip of the driving authorization records are read out with an offboard diagnostic system 3 and are processed further with the offboard diagnostic system. For this purpose, a computer system with corresponding reading devices 1a for the transponder keys or with corresponding transmitting and reception systems S/E, such as in the exemplary embodiment in FIG. 2, is installed for the Keyless Go systems in the customer reception of the workshop. Of course, both inputting possibilities (that is, for transponder keys and for Keyless Go systems) should be connected to the computer system in the customer reception.

The computer system 3 in the customer reception expediently has a communication link to further more powerful computer systems and databases of the offboard diagnostic system. Networking with a diagnostic server and a central customer database in a service center is already standard practice in offboard diagnostic systems and can also be used advantageously in conjunction with this invention.

The data quantities to be transmitted are reduced in a method which is particularly advantageous for Keyless Go systems and which uses checksum testing. In Keyless Go systems, the power supply to the electronic component in the authentication element is provided exclusively via an integrated battery. In order to save the capacity of the battery, it is therefore desirable, as far as possible, to avoid double transmission of identical data through repeated memory processes. This can be avoided according to the invention in that after an onboard short test result is successfully stored for the first time, and after its successful transmission to the chip of the electronic driving authorization records, a checksum is formed over the transmitted useful data and diagnostic data. The date and time are not included in the checksum. At the next transmission attempt it is determined whether the checksum of the diagnostic data to be transmitted has changed in comparison to the checksum from the last transmission. If another checksum is produced, the entire diagnostic data including the new date and current time are transmitted.

If the checksum over the diagnostic data has not changed, only the current date and current time are transmitted.

FIG. 2 shows components of a diagnostic system according to the invention for Keyless Go driving authorization systems. The onboard network architecture, communication systems of the control units in the vehicle and control units in the vehicle remain the same as in the exemplary embodiment according to FIG. 1. The offboard diagnostic system with its possible server networking and its database connections also remains essentially the same. Here too, a computer system in the customer reception is networked to the offboard diagnostic system.

Differences occur as a result of the Keyless Go system. That is, adaptations are necessary for the transmitting and receiving devices for operating the Keyless Go systems. At least one transmitting and receiving unit S/E for reading in the chip data from the authentication element 20 has to be provided in the vehicle. The unit is also networked to the bus systems in the vehicle. In the customer reception, an identical or similar transmitting and receiving unit is connected to the computer system 3 there. The computer system preferably has in parallel a reading-in device 1a for transponder keys. The short diagnostic test which is implemented in a control unit in the vehicle operates according to the same method or a similar method as already disclosed in the exemplary embodiment according to FIG. 1. However, the diagnostic data are stored in a memory area of the chip card of the authentication element, from which they are then read out in the customer reception.

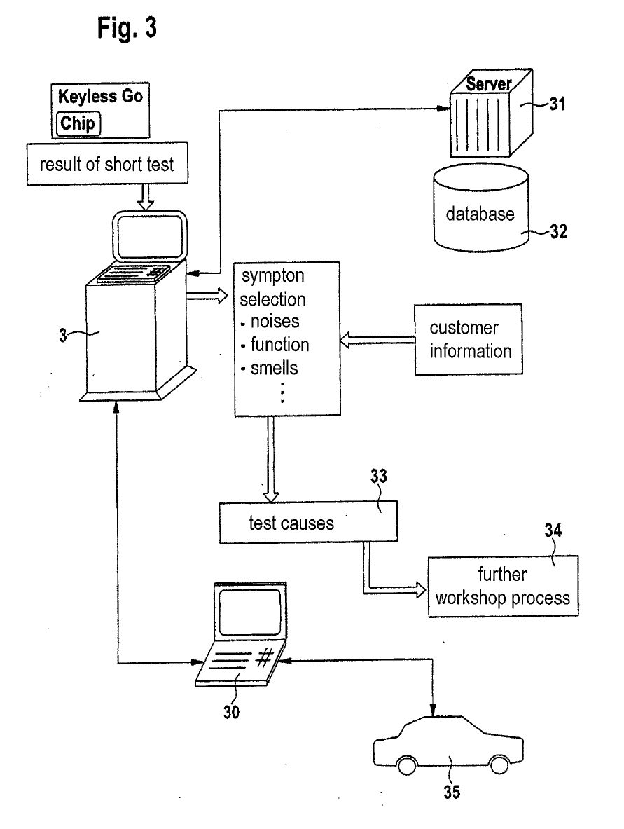

The connection of the onboard short diagnostic test to an offboard diagnostic system and to a computer system in the customer reception permits, for example, a working sequence such as is illustrated in FIG. 3 in the customer reception. The result of the onboard short diagnostic test is read from the electronic driving authorization records of the motor vehicle into the computer system 3 installed in the customer reception and is already prepared there by a program module of the diagnostic program running in the background. The extent to which the result of the short test is processed depends on the particular offboard diagnostic system that is used.

In all cases, according to the invention, the result of the short test with its fault messages is displayed to the service employee. This is done with a selection menu from which the service employee can select individual menu items and can enter further machine-processable customer information relating to these selected menu items. Such customer information can be acquired from the driver of the vehicle when the driver hands in the vehicle key or the Keyless Go authentication element to the customer reception. The machine processability can be ensured here with an input mask by virtue of the fact that the offboard diagnostic program running in the background interrogates further ambient data relating to a selected reported fault in a menu, with respect to which data the service employee can enter the corresponding alternative as applicable or not applicable in a selection menu on the system display when he questions the customer. One possibility for this is, for example, a selection of symptoms during which, on the basis of the information from the customer, symptoms such as noises, functioning and non-functioning functions such as smells, etc. are registered.

The information, the symptoms and the diagnostic data acquired in this way are processed by the diagnostic program, which can run, for example, on the server 31, by evaluating an associated database 32, and/or can be passed to a diagnostic tester 30 for the more-wide ranging workshop diagnosis and repair, which diagnostic tester 30 is connected to the diagnostic interface of the motor vehicle 35. Selected cause tests 33 can then be performed with the tester and the further workshop process 34 can be generated from the test results.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-4. (canceled)

5. A diagnostic system for motor vehicles having electronic driving authorization records, said diagnostic system having onboard components and offboard components, with the onboard components being connected to one another via communication links, and the offboard components having a communication link to one another; wherein,
at least one of the onboard components implements a short diagnostic test, which collects and buffers diagnostic data onboard;
said diagnostic data are transmitted to a memory area in an electronic driving authorization records component, and stored; and
said diagnostic data are read out again from the electronic driving authorization records component with the offboard components of the diagnostic system, and processed further.

6. The diagnostic system as claimed in claim 5, wherein the electronic driving authorization records component is one of a transponder key and an authentication element of a Keyless Go system.

7. The diagnostic system as claimed in claim 5, wherein:
at least one of the offboard components is a computer system in a customer reception operation of a servicing company;
the diagnostic data read out from the electronic driving authorization records are displayed on the computer system using an offboard diagnostic program; and
further customer details are input in addition to the individual fault messages, using an input mask.

8. The diagnostic system as claimed in claim 5, wherein:
a checksum is formed over the buffered diagnostic data; and
after the diagnostic data have been transmitted for the first time further transmissions of diagnostic data occur only if the checksum of the buffered diagnostic data has changed.

9. A method for diagnosing systems in a vehicle having onboard components that communicate with each other via a first communication link, said method comprising:
at least one of said onboard components performing a short diagnostic test, which collects and buffers diagnostic data on board the vehicle;
transmitting said diagnostic data to a memory area in a transportable electronic unit that stores electronic driving authorization records for said vehicle;
offboard data processing components reading said diagnostic data out of said transportable electronic unit, and processing said diagnostic data further.

10. The method according to claim 9, wherein the transportable electronic unit is one of a transponder key, and an authentication element of a keyless go system.

11. The method according to claim 9, wherein:
at least one of said offboard data processing components is a computer system in a customer reception operation of a vehicle service facility; and
further customer details are input in addition to the individual fault messages using an input mask.

12. The diagnostic system as claimed in claim 9, wherein:
a checksum is formed over the buffered diagnostic data; and
after the diagnostic data have been transmitted for the first time further transmissions of diagnostic data occur only if the checksum of the buffered diagnostic data has changed.
